(19) United States
(12) Patent Application Publication
(10) Pub. No.: US 2023/0394514 A1
(43) Pub. Date: Dec. 7, 2023

(54) ENABLING DIGITAL ADVERTISING IDENTIFIER CONSENT CONVERSION FOR TRACKING ACROSS DIFFERENT APPLICATIONS

(71) Applicant: Catalina Marketing Corporation, St. Petersburg, FL (US)

(72) Inventors: Zubin Singh, St. Petersburg, FL (US); Stan Turek, St. Petersburg, FL (US); Jared Hislop, St. Petersburg, FL (US)

(21) Appl. No.: 18/032,062

(22) PCT Filed: Oct. 15, 2021
(86) PCT No.: PCT/US2021/055209

§ 371 Date: Apr. 14, 2023

Related U.S. Application Data
(60) Provisional application No. 63/093,070, filed on Oct. 16, 2020.

(51) Int. Cl. G06Q 30/0207; G06Q 30/0251

(52) U.S. Cl. CPC G06Q 30/0207; G06Q 30/0255

(57) ABSTRACT

A method including receiving, in a first service provider, a request for downloading a first application from a user, including an authorization for the first service provider to track data activity from the first application is provided. The method includes transmitting, to a second service provider, a user identifier, wherein the second service provider is enabled to place an advertisement in a display for the first application, placing the advertisement from the second service provider in the first application, wherein the advertisement entices the user to download a second application when the user identifier indicates that the user is a former subscriber to the second application, and rewarding a user account in the first service provider when the user allows tracking data activity by the second service provider from the second application. A system and a non-transitory, computer-readable medium storing instructions to perform the above method are also provided.

### CROSS-REFERENCE TO RELATED APPLICATIONS

The present disclosure is related to and claims priority under the PCT to U.S. Prov. Appln. No. 63/093,070, entitled “ENABLING DIGITAL ADVERTISING IDENTIFIER CONSENT CONVERSION FOR TRACKING ACROSS DIFFERENT APPLICATIONS,” to Singh, et-al. filed on Oct. 16, 2020, the contents of which are hereby incorporated by reference in their entirety, for all purposes.

### BACKGROUND

### Field

The present disclosure is related to digital advertising via mobile applications. More specifically, the present disclosure is directed to methods and systems to recover transaction tracking permissions from users of one mobile application through a different mobile application having transaction tracking enabled.

### Brief Background Description

Current trends in digital data collection and user-tracking from mobile devices have put a heavy burden on service providers to find mechanisms for preserving user identification information (e.g., for a digital advertising or marketing server). Many platforms have relied on data collection from network providers or device manufacturers, but privacy concerns in the context of current developments have compelled the latter to steer away from automatic device tracking and data-sharing. This has exposed many advertising platforms and other data-dependent services to inability to track digital user interactions that may seriously impact the digital advertising ecosystem.

### BRIEF DESCRIPTION OF THE DRAWINGS

FIG. 1 illustrates an example architecture suitable for presenting personalized digital promotions to a consumer, according to some embodiments.

FIG. 2 is a block diagram illustrating an example server and client from the architecture of FIG. 1, according to certain aspects of the disclosure.

FIG. 3 illustrates blocks and devices in a method enabling digital advertising identifier consent conversion for tracking across different applications, according to some embodiments.

FIG. 4 is a flow chart illustrating steps in a method for enabling digital advertising identifier consent conversion for tracking across different applications, according to some embodiments.

FIG. 5 is a flow chart illustrating steps in a method for requesting a consumer to enable transaction tracking across different applications installed in a client device, according to some embodiments.

FIG. 6 is a block diagram illustrating an example computer system with which the client and server of FIGS. 1 and 2 and the methods of FIGS. 4 and 5 can be implemented.

In the figures, elements and steps denoted by the same or similar reference numerals are associated with the same or similar elements and steps, unless indicated otherwise.

### SUMMARY

In a first embodiment, a computer-implemented method includes: receiving, in a first service provider, a request for downloading a first application from a user, the request including an authorization for the first service provider to track data activity from the first application. The computer-implemented method also includes transmitting, to a second service provider, a user identifier, wherein the second service provider is enabled to place an advertisement in a display for the first application and placing the advertisement from the second service provider in the first application. The advertisement entices the user to download a second application when the user identifier indicates that the user is a former subscriber to the second application. The computer-implemented method also includes rewarding a user account in the first service provider when the user allows tracking data activity by the second service provider from the second application.

In a second embodiment, a computer-implemented method includes requesting an advertising space in a display for a first application hosted by a first service provider and receiving a user identifier from the first service provider when a user uploads the first application in a mobile device. The computer-implemented method also includes correlating the user identifier with a user identifier associated with a second application in a database and preparing a payload for the advertising space. The payload includes a request for the user to upload the second application in the mobile device. The computer-implemented method also includes requesting the user to enable a transaction tracking from the second application and rewarding a user account in the first service provider when the user enables the transaction tracking from the second application.

In a third embodiment, a system includes one or more processors and a memory storing instructions which, when executed by the one or more processors, cause the system to perform a method. The method includes receiving, in a first service provider, a request for downloading a first application from a user, the request including an authorization for the first service provider to track data activity from the first application. The method also includes transmitting, to a second service provider, a user identifier, wherein the second service provider is enabled to place an advertisement in a display for the first application, placing the advertisement from the second service provider in the first application, wherein the advertisement entices the user to download a second application when the user identifier indicates that the user is a former subscriber to the second application, and rewarding a user account in the first service provider when the user allows tracking data activity by the second service provider from the second application.

In another embodiment, a non-transitory, computer-readable medium stores instructions which, when executed by a processor in a computer, cause the computer to perform a method. The method includes receiving, in a first service provider, a request for downloading a first application from a user, the request including an authorization for the first service provider to track data activity from the first application. The method also includes transmitting, to a second service provider, a user identifier, wherein the second service provider is enabled to place an advertisement in a display for the first application, placing the advertisement from the second service provider in the first application, wherein the advertisement entices the user to download a second application when the user identifier indicates that the user is a former subscriber to the second application, and rewarding a user account in the first service provider when the user allows tracking data activity by the second service provider from the second application.

In yet another embodiment, a system includes a first means for storing instructions, and a second means for executing the instructions to cause the system to perform operations. The operations include to receive, in a first service provider, a request for downloading a first application from a user, the request including an authorization for the first service provider to track data activity from the first application. The operations also include to transmit, to a second service provider, a user identifier, wherein the second service provider is enabled to place an advertisement in a display for the first application, to place the advertisement from the second service provider in the first application, wherein the advertisement entices the user to download a second application when the user identifier indicates that the user is a former subscriber to the second application, and to reward a user account in the first service provider when the user allows tracking data activity by the second service provider from the second application.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Many current mobile device applications use semi persistent device tracking capabilities to record user transactions (e.g., purchase habits, needs, entertainment activities, and the like) and thus adjust and personalize targeted offers and advertisements to the user. The tracking capability is thus not only beneficial for the service provider as it drives consumption and revenue, but also highly beneficial for the user, who receives offers, rewards, and opportunities directly tuned to their needs and desires. Current trends in semi persistent device tracking capabilities for mobile applications may require that each service provider hosting an application enable separately, and expressly allow, advertising and marketing transaction tracking from the user upon download. As a result, when the user changes, modifies, or updates a mobile device or the operating system of the mobile device, many of the already installed applications may be opted-out of advertising and marketing tracking capabilities for the user transactions. In many instances, the user may not be aware that these capabilities have been lost. On the other hand, the service providers hosting the different applications may simply stop receiving tracking information from that particular user, who is identified through an identification for advertisers. Accordingly, it is desirable to implement methods and systems that enable service providers to recoup users whose identification have dropped from their history logs because of unintentional failure to explicitly allow tracking capabilities.

### Example System Architecture

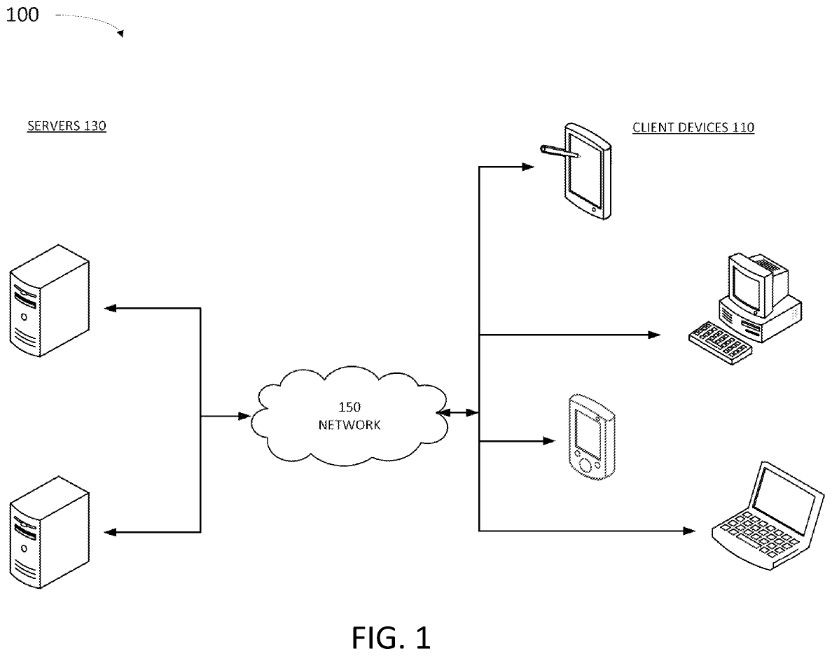

FIG. 1 illustrates an example architecture 100 for a transaction tracking engine suitable for practicing some implementations of the disclosure. Architecture 100 includes servers 130 and client devices 110 coupled over a network 150. Client devices 110 may include, for example, desktop computers, mobile computers, tablet computers (e.g., including e-book readers), mobile devices (e.g., a smartphone or PDA), or any other devices having appropriate processor, memory, and communications capabilities for accessing the image search engine and the history log on one or more of servers 130. One of the many servers 130 is configured to host a memory, including instructions which, when executed by a processor, cause the server 130 to perform at least some of the steps in methods as disclosed herein. In some embodiments, the transaction tracking engine requests a user of the mobile device or permission to track user transactions through one or more applications installed in the mobile device. In some embodiments, architecture 100 is configured to provide personalized digital promotions to a consumer, who may be the consumer of client device 110. The digital promotion payload may be retrieved from a digital promotion database, a marketing analysis database, or a history log database communicatively coupled with the server.

Servers 130 may include any device having an appropriate processor, memory, and communications capability for hosting the history log, the digital promotion database, and a transaction tracking engine. The transaction tracking engine may be accessible by various clients 110 over the network 150. In some embodiments, servers 130 may include a dynamic creative rendering server, a publisher, or supply side platform (SSP) server, and a demand side platform (DSP) server. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

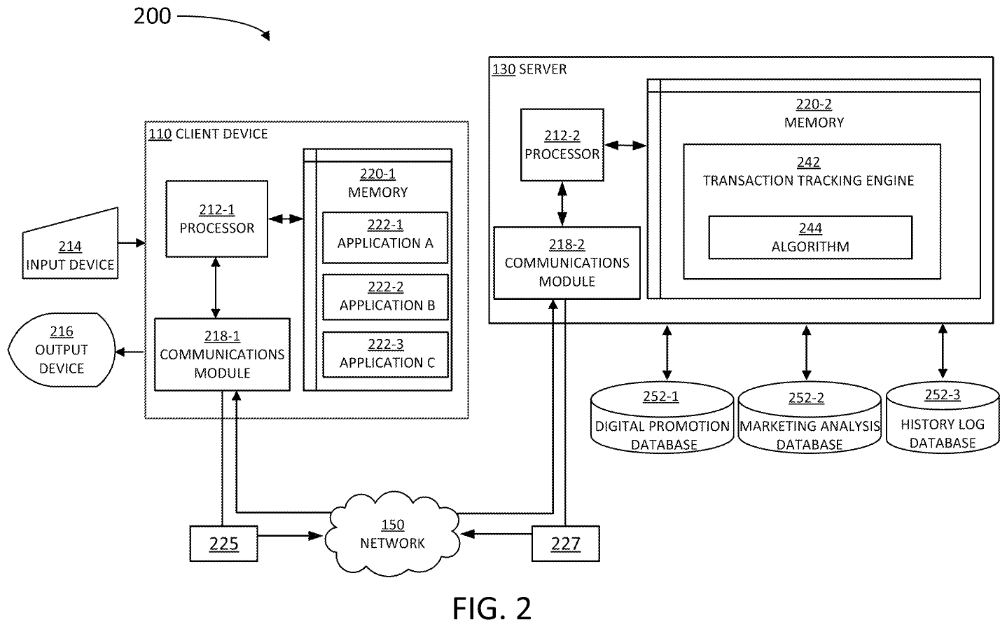

FIG. 2 is a block diagram 200 illustrating an example server 130 and client device 110 in the architecture 100 of FIG. 1, according to certain aspects of the disclosure. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices on the network. Communications modules 218 can be, for example, modems or Ethernet cards. Client device 110 may be coupled with an input device 214 and with an output device 216. Input device 214 may include a keyboard, a mouse, a pointer, or even a touch-screen display that a consumer may use to interact with client device 110. Likewise, output device 216 may include a display and a speaker with which the consumer may retrieve results from client device 110. Client device 110 may also include a processor 212-1, configured to execute instructions stored in a memory 220-1, and to cause client device 110 to perform at least some of the steps in methods consistent with the present disclosure. Memory 220-1 may further include applications A (222-1), B (222-2), and C (222-3), hereinafter, collectively referred to as “applications 222.” Applications 222 include specific instructions which, when executed by processor 212-1, cause a digital promotion payload 227 from server 130 to be displayed for the consumer. Digital promotion payload 227 may include multiple digital promotions or coupons presented to the consumer by server 130, and the consumer may store at least some of the digital promotions or coupons from digital promotion payload 227 in memory 220-1.

In some embodiments, applications 222 may include a mobile wallet application, configured to store a value offer (e.g., a coupon, a discount, and the like), which has been selected (e.g., “clipped”) by the consumer from any one of the multiple digital promotions or coupons in digital promotion payload 227. Further, in some embodiments, a mobile wallet application may associate the value offer selected by the consumer to a frequent shopper ID (FSC-ID) for a retailer. Applications 222 may be installed in memory 220-1 by the manufacturer, together with the installation of an operating system that controls all hardware operations of client device 110. Moreover, in some embodiments, a consumer may download a retailer application (e.g., application C 222-3) in client device 110 for the retailer. The consumer may have an FSC-ID associated with application C 222-3. In some embodiments, in addition to one or more “brick and mortar” physical locations of stores for the retailer, the retailer may host an online shopping outlet hosted by a network server (e.g., server 130).

Server 130 includes a memory 220-2, a processor 212-2, and a communications module 218-2. Processor 212-2 is configured to execute instructions, such as instructions physically coded into processor 212-2, instructions received from software in memory 220-2, or a combination of both. Memory 220-2 includes a transaction tracking engine 242, configured to request the user of client device 110 authorization for tracking of transactions performed by any one or all of applications 222. When the user authorizes tracking of transactions for one or more of applications 222, transaction tracking engine 242 may direct a server 130 associated with advertising or with a retailer to prepare digital promotion payload 227. Accordingly, server 130 may be configured to integrate images, videos, and other multimedia files from a digital promotion database 252-1 into a digital promotion payload 227. Transaction tracking engine 242 may push digital promotions from digital promotion database 252-1 to a consumer of client device 110 that is a consumer of a retailer store or chain of stores through applications 222 or a web browser installed in client device 110. Accordingly, applications 222 may be installed by server 130 and perform scripts and other routines provided by server 130. In some embodiments, at least one of applications 222 may be configured to display digital promotion payload 227 provided by transaction tracking engine 242. In some embodiments, client device 110 may provide data 225 to server 130. Data 225 may include a client device identifier 225, or a user identifier in a network hosted by server 130.

Digital promotion payload 227 is integrated based on information retrieved from a marketing analysis database 252-2 and a history log database 252-3. Digital promotion database 252-1, marketing analysis database 252-2, and history log database 252-3 will be collectively referred to, hereinafter, as “databases 252.” History log database 252-3 includes the purchase history of multiple consumers listed in marketing analysis database 252-2. To achieve this, in some embodiments, an algorithm 244 stores commands which, when executed by processor 212-2, causes server 130 to integrate digital promotion payload 227. Algorithm 244 may include a neural network (NN) trained over marketing analysis database 252-2 and history log database 252-3, to select digital promotion payload 227 targeted to the specific preferences of a consumer when the consumer grants any one of applications 222 to track user transactions. In some embodiments, an SSP server hosting the network site accessed through application 222 may be different from a DSP server hosting transaction tracking engine 242.

In one or more implementations, digital promotion database 252-1 integrates digital promotion payloads including coupons and digital promotions for multiple products on sale by a retailer having one or more stores. A marketing analysis database 252-2 may include a list of frequent consumers of a retailer. The retailer may create, update, and maintain digital promotion database 252-1, marketing analysis database 252-2, and history log database 252-3. In that regard, digital promotion database 252-1, marketing analysis database 252-2, and history log database 252-3 may be hosted by the retailer, while the transaction tracking engine 242 may be hosted by a DSP server or a dynamic creative rendering server. Accordingly, the DSP server may have access to one or more digital promotion databases 252-1, to one or more marketing analysis databases 252-2, and to one or more history log databases 252-3 through business agreements with one or more retailers.

In certain aspects, processor 212-2 in a server 130 hosted by a retailer is configured to determine data for history log database 252-3 by obtaining consumer purchasing data identifying the consumer via the frequent shopper identification used at multiple purchasing events in multiple locations, over a pre-selected span of time. In some embodiments, history log database 252-3 includes online purchasing history for the consumer through applications 222 or a network browser. Processors 212-1 and 212-2 will be collectively referred, hereinafter, as “processors 212.” Memories 220-1 and 220-2 will be collectively referred, hereinafter, as “memories 220.”

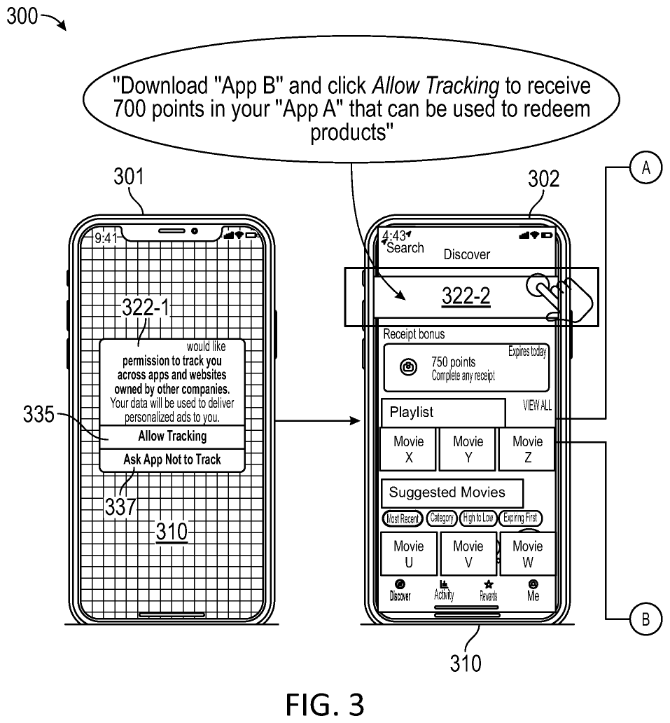

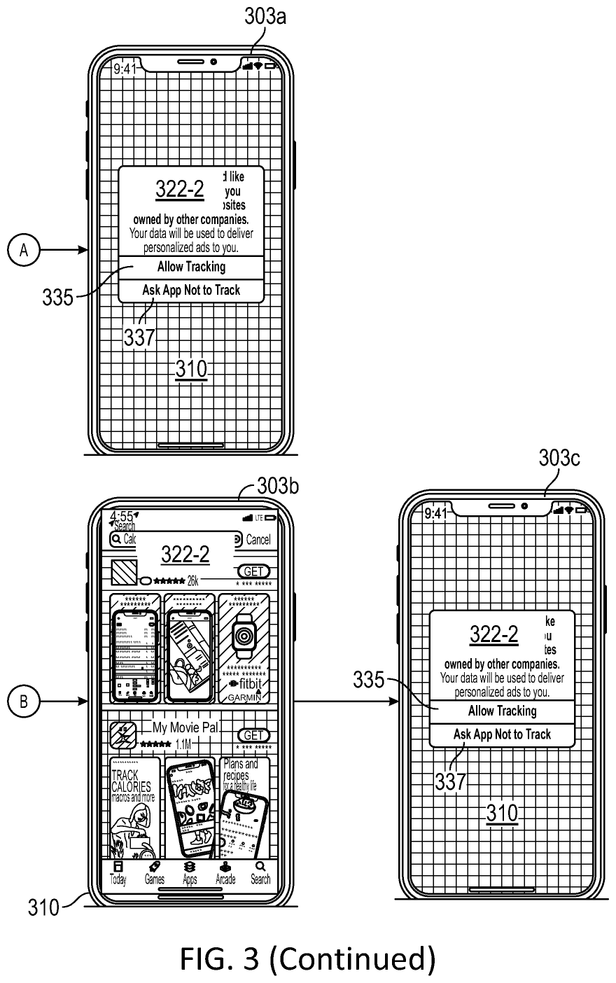

FIG. 3 illustrates blocks in a method 300 for enabling digital advertising identifier consent conversion for tracking across different applications 322-1 and 322-2 (hereinafter, collectively referred to as “applications 322”) installed in a client device 310, as disclosed herein. Client device 310 has a device identification, and may also be associated with a consumer identification with any one of the service providers hosting one or more of applications 322. Identifications are strings of alphanumeric characters that identify a consumer uniquely, across multiple retail stores and services. When a consumer accesses one of applications 322 that has enabled advertising transaction tracking, the transaction is associated with the identification. The host of the application can then store the consented-in transaction data and the identification in a database for performing marketing analysis, and the like. For example, the host may include a digital promotion server, or an advertising technology server, configured to prepare an advertising campaign involving one or more items or products purchased by the consumer. Using the identification, the purchasing data generated by the consumer may be tracked down and lumped into a single consumer by the digital promotion server.

In block 301, a consumer downloads a first application 322-1 (e.g., “Application A”) hosted by a first service provider into mobile device 310 and consents to allow tracking 335 of transaction data through the first application by the first service provider. In some embodiments, upon downloading application 322-1, the consumer may ask not to track 337 transaction data from application 322-1.

In block 302, a second service provider may have access to application 322-1 via an advertisement spot. Accordingly, the second service provider may place an advertisement payload in the display of application 322-1. The second service provider may have access to the consumer identification, from application 322-1. Accordingly, the second service provider may correlate the identification for the consumer with a database storing prior identifications that the second service provider has serviced in the past. The second service provider may identify a second application 322-2 to which the consumer had formerly subscribed, but for which there is no further transaction data associated with the identification. When such a gap appears in the transaction data for an identification, this may indicate that the consumer may have updated the operating system in mobile device 310 without explicitly enabling advertising and marketing transaction tracking for application 322-2 with the new operating system, or a new mobile device 310.

In some embodiments, application 322-2 may be hosted by the second service provider. In yet other embodiments, application 322-2 may be hosted by a client of the second service provider, or by a remote server coupled with the second service provider through past transactions. The second service provider may then use the advertisement payload to entice the consumer to enable transaction tracking for application 322-2. In some embodiments, the enticement for the consumer may include an offer of a reward for a consumer account in the first service provider, associated with application 322-1.

In block 303a, the consumer may enable transaction tracking 335 through the second application (e.g., “Application B”) when the second application is already installed in the consumer's mobile device. Accordingly, application 322-2 may provide the identification for the consumer to the second service provider, and the second service provider may verify the original correlation identifying the identification with the second application. When the correlation is verified to correctly identify the consumer and the second application, then the first service provider may execute the reward for the consumer account associated with the first application. In some embodiments, the consumer may ask the second service provider not to track 337 transactions from application 322-2.

In block 303b, the consumer may download application 322-2 to mobile device 310 when application 322-2 is not already installed therein. Such a scenario may arise, for example, when the consumer has changed mobile device 310, or updated the operating system, or inadvertently deleted application 322-2 from mobile device 310. In some embodiments, the consumer may download application 322-2 from the second service provider. In yet other embodiments, the consumer may download application 322-2 from a client of the second service provider, or from a remote server coupled with the second service provider through a past transaction.

In block 303c, the consumer enables advertising and marketing transaction tracking in the second application, for the second service provider.

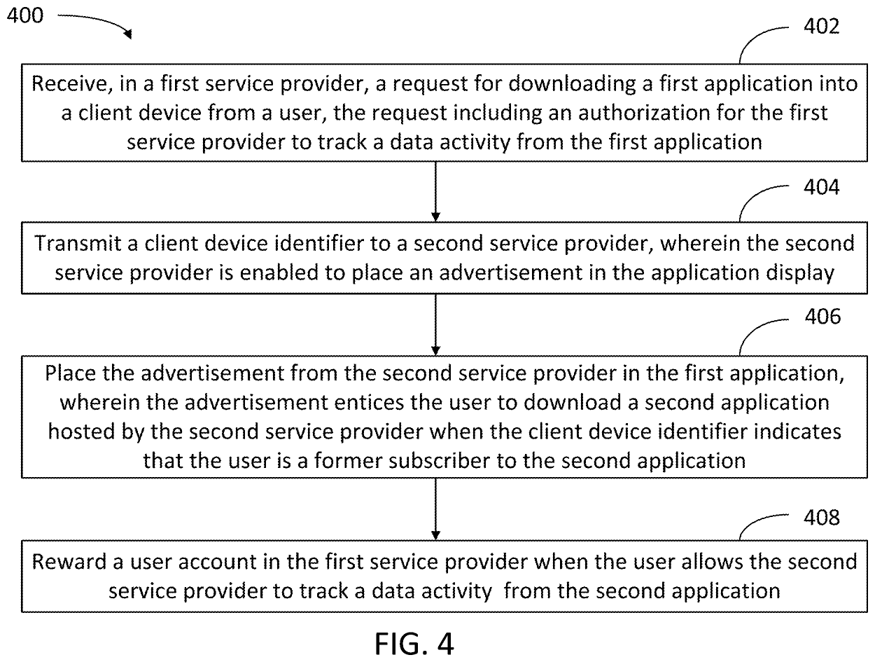

FIG. 4 is a flowchart illustrating steps in a method 400 for enabling digital advertising identifier consent conversion for tracking across different applications, according to some embodiments. Method 400 may be performed at least partially by any one of the plurality of servers (cf. servers 130). For example, at least some of the steps in method 400 may be performed by one component in a system, including a mobile device running code for a browser and an application to access the publisher website or application, and an advertising and marketing technology engine coupled with the digital coupon and promotion technology engine that processes logic to select a digital promotion playlist for a dynamic creative rendering server to push the digital promotion payload to the mobile device, the system also including a publisher SSP that requests digital promotion bids from, and is registered with, a digital promotion technology engine (e.g., architectures 100 and 200, client devices 110, applications 222, and transaction tracking engine 242). Accordingly, at least some of the steps in method 400 may be performed by a processor executing commands stored in a memory of the server or the mobile device, or accessible by the server or the mobile device (e.g., processors 212, memories 220, and databases 252). Further, in some embodiments, at least some of the steps in method 400 may be performed overlapping in time, simultaneously, almost simultaneously, or in a different order from the order illustrated in method 400. Moreover, a method consistent with some embodiments disclosed herein may include at least one, but not all, of the steps in method 400.

Step 402 includes receiving, in a first service provider, a request for downloading a first application into a client device from a user, the request including an authorization for the first service provider to track data activity from the first application. In some embodiments, step 402 includes providing to the first service provider the client device identifier when a transaction is performed by the first application with the client device. In some embodiments, step 402 includes providing to the client device, for storage, a first identification value for the user in a network hosted by the first service provider based on the client device identifier.

Step 404 includes transmitting a client device identifier to a second service provider, wherein the second service provider is enabled to place an advertisement in the application display. In some embodiments, step 404 includes identifying the client device as a new client device for an old user in a network hosted by the first service provider, and installing the second application in the client device. In some embodiments, step 404 includes providing to the first service provider or to the second service provider the client device identifier when a transaction is performed by the second application with the client device. In some embodiments, step 404 includes providing to the client device, for storage, a second identification value for the user in a network hosted by the second service provider based on the client device identifier.

Step 406 includes placing the advertisement from the second service provider in the application, wherein the advertisement entices the user to download a second application hosted by the second service provider when the client device identifier indicates that the user is a former subscriber to the second application. In some embodiments, step 406 includes querying the client device for an authorization to install the second application when the second service provider identifies the client device identifier as a previous account user.

Step 408 includes rewarding a user account in the first service provider when the user allows tracking a data activity by the second server provider from the second application. In some embodiments, step 408 includes providing a personalized value added certificate to the user for a product included in the advertisement from the second service provider. In some embodiments, step 408 includes rewarding a user account in the second service provider when the user allows tracking data activity from the second application. In some embodiments, step 408 includes rewarding a user account in the second service provider when the second application detects a transaction with the client device associated with the advertisement.

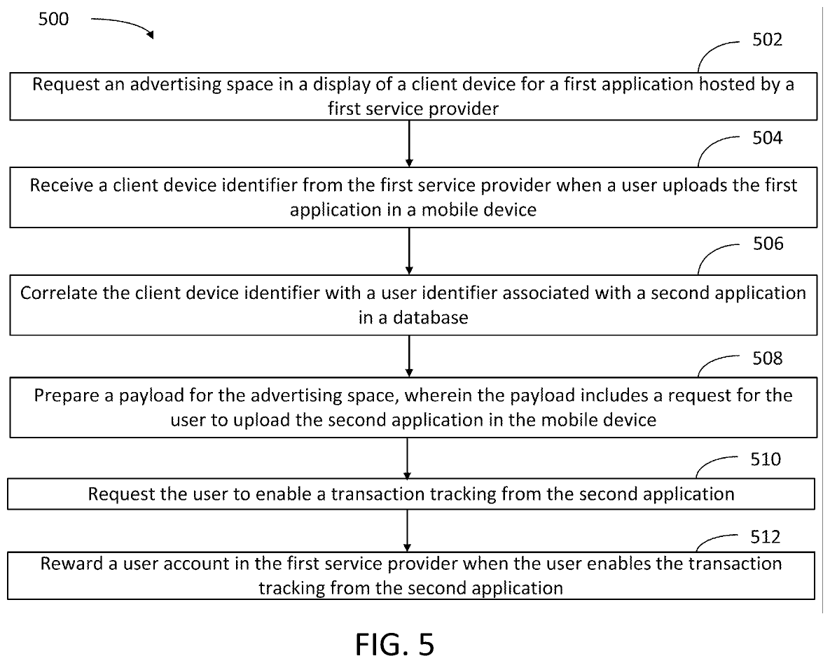

FIG. 5 is a flow chart illustrating steps in a method 500 for requesting, a consumer to enable transaction tracking across different applications installed in a client device, according to some embodiments. Method 500 may be performed at least partially by any one of the plurality of servers (cf. servers 130). For example, at least some of the steps in method 500 may be performed by one component in a system, including a mobile device running code for a browser and an application to access the publisher website or application, and an advertising and marketing technology engine coupled with the digital coupon and promotion technology engine that processes logic to select a digital promotion playlist for a dynamic creative rendering server to push the digital promotion payload to the mobile device, the system also including a publisher SSP that requests digital promotion bids from, and is registered with, a digital promotion technology engine (e.g., architectures 100 and 200, client devices 110, applications 222, and transaction tracking engine 242). Accordingly, at least some of the steps in method 500 may be performed by a processor executing commands stored in a memory of the server or the mobile device, or accessible by the server or the mobile device (e.g., processors 212, memories 220, and databases 252). Further, in some embodiments, at least some of the steps in method 500 may be performed overlapping in time, simultaneously, almost simultaneously, or in a different order from the order illustrated in method 500. Moreover, a method consistent with some embodiments disclosed herein may include at least one, but not all, of the steps in method 500.

Step 502 includes requesting an advertising space in a display of a client device for a first application hosted by a first service provider. In some embodiments, step 502 includes providing to the client device, for storage, a first identification value for the user in a network hosted by the first service provider based on the client device identifier.

Step 504 includes receiving a client device identifier from the first service provider when a user uploads the first application in a mobile device. In some embodiments, step 504 includes providing to the first service provider or to a second service provider the client device identifier when a transaction is performed by the second application with the client device, wherein the second service provider hosts the second application. In some embodiments, step 504 includes providing to the client device, for storage, a second identification value for the user in a network hosted by the second service provider based on the client device identifier.

Step 506 includes correlating the client device identifier with a user identifier associated with a second application in a database. In some embodiments, step 506 includes querying the client device for an authorization to install the second application when the first service provider identifies the client device identifier as a previous account user.

Step 508 includes preparing a payload for the advertising space, wherein the payload includes a request for the user to upload the second application in the mobile device. In some embodiments, step 508 includes selecting the payload based on the transaction tracking from the second application.

Step 510 includes requesting the user to enable a transaction tracking from the second application.

Step 512 includes rewarding a user account in the first service provider when the user enables the transaction tracking from the second application.

In some embodiments, the benefits of systems and methods as disclosed herein may be enhanced with partnerships with third party service providers, retailers, and brand manufacturers.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

### Hardware Overview

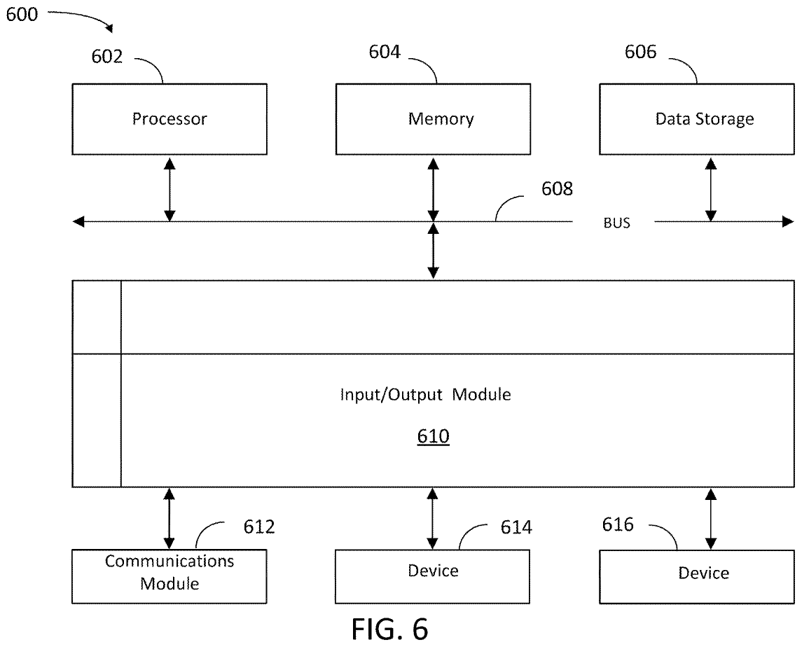

FIG. 6 is a block diagram illustrating an exemplary computer system 600 with which the client device 110 and server 130 of FIGS. 1 and 2, and the methods of FIGS. 4 and 5 can be implemented. In certain aspects, the computer system 600 may be implemented using hardware or a combination of software and hardware, either in a dedicated server, or integrated into another entity, or distributed across multiple entities.

Computer system 600 (e.g., client device 110 and server 130) includes a bus 608 or other communication mechanism for communicating information, and a processor 602 (e.g., processors 212) coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, e.g., one or more modules of computer program instructions encoded on a computer-readable medium for execution by, or to control the operation of, the computer system 600, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and inter-coupled by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled with bus 608 for storing information and instructions. Computer system 600 may be coupled via input/output module 610 to various devices. Input/output module 610 can be any input/output module. Exemplary input/output modules 610 include data ports such as USB ports. The input/output module 610 is configured to connect to a communications module 612. Exemplary communications modules 612 (e.g., communications modules 218) include networking interface cards, such as Ethernet cards and modems. In certain aspects, input/output module 610 is configured to connect to a plurality of devices, such as an input device 614 (e.g., input device 214) and/or an output device 616 (e.g., output device 216). Exemplary input devices 614 include a keyboard and a pointing device, e.g., a mouse or a trackball, by which a consumer can provide input to the computer system 600. Other kinds of input devices 614 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 616 include display devices, such as an LCD (liquid crystal display) monitor, for displaying information to the consumer.

According to one aspect of the present disclosure, the client device 110 and server 130 can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be inter-coupled by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires forming bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

### Recitation of Embodiments

Embodiments consistent with the present disclosure may include any one of the following:

Embodiment I: A computer-implemented method includes receiving, in a first service provider, a request for downloading a first application into a client device from a user, the request including an authorization for the first service provider to track a data activity from the first application. The computer-implemented method also includes transmitting, to a second service provider, a client device identifier, wherein the second service provider is enabled to place an advertisement in a display for the first application, placing the advertisement from the second service provider in the first application, wherein the advertisement entices the user to download a second application hosted by the second service provider when the client device identifier indicates that the user is a former subscriber to the second application, and rewarding a user account in the first service provider when the user allows the second service provider to track a data activity by the second application.

Embodiment II: A system includes one or more processors and a memory storing instructions which, when executed by the one or more processors cause the system to perform operations. The operations include to receive, in a first service provider, a request for downloading a first application into a client device from a user, the request including an authorization for the first service provider to track a data activity from the first application, and to transmit, to a second service provider, a client device identifier, wherein the second service provider is enabled to place an advertisement in a display for the first application. The operations also include to place the advertisement from the second service provider in the first application, wherein the advertisement entices the user to download a second application hosted by the second service provider when the client device identifier indicates that the user is a former subscriber to the second application, to reward a user account in the first service provider when the user allows the second service provider to track data activity from the second application, and to provide to the first service provider the client device identifier when a transaction is performed by the first application with the client device.

Embodiment III: A computer-implemented method includes requesting an advertising space in a display of a client device for a first application hosted by a first service provider, receiving a client device identifier from the first service provider when a user uploads the first application in a mobile device, correlating the client device identifier with a user identifier associated with a second application in a database, preparing a payload for the advertising space, wherein the payload includes a request for the user to upload the second application in the mobile device, requesting the user to enable a transaction tracking from the second application, and rewarding a user account in the first service provider when the user enables the transaction tracking from the second application.

In addition, any one of embodiments I, II and III may be combined with the following elements, in any permutation:

Element 1, further including providing to the first service provider the client device identifier when a transaction is performed by the first application with the client device. Element 2, further including identifying the client device as a new client device for an old user in a network hosted by the first service provider, and installing the second application in the client device. Element 3, further including providing to the client device, for storage, a first identification value for the user in a network hosted by the first service provider based on the client device identifier. Element 4, further including providing to the first service provider or to the second service provider the client device identifier when a transaction is performed by the second application with the client device. Element 5, further including providing to the client device, for storage, a second identification value for the user in a network hosted by the second service provider based on the client device identifier. Element 6, further including querying the client device for an authorization to install the second application when the second service provider identifies the client device identifier as a previous account user. Element 7, wherein rewarding a user account in the first service provider includes providing a personalized value added certificate to the user for a product included in the advertisement from the second service provider. Element 8, further including rewarding a user account in the second service provider when the user allows tracking data activity from the second application. Element 9, further including rewarding a user account in the second service provider when the second application detects a transaction with the client device associated with the advertisement.

Element 10, further including providing to the client device, for storage, a first identification value for the user in a network hosted by the first service provider based on the client device identifier. Element 11, further including providing to the first service provider or to a second service provider the client device identifier when a transaction is performed by the second application with the client device, wherein the second service provider hosts the second application. Element 12, further including providing to the client device, for storage, a second identification value for the user in a network hosted by a second service provider based on the client device identifier, wherein the second service provider also hosts the second application. Element 13, further including querying the client device for an authorization to install the second application when the first service provider identifies the client device identifier as a previous account user. Element 14, wherein preparing a payload for the advertising space includes selecting the payload based on the transaction tracking from the second application.

1. A computer-implemented method, comprising:
receiving, in a first service provider, a request for downloading a first application into a client device from a user, the request including an authorization for the first service provider to track a data activity from the first application;
transmitting, to a second service provider, a client device identifier, wherein the second service provider is enabled to place an advertisement in a display for the first application;
placing the advertisement from the second service provider in the first application, wherein the advertisement entices the user to download a second application hosted by the second service provider when the client device identifier indicates that the user is a former subscriber to the second application; and
rewarding a user account in the first service provider when the user allows the second service provider to track a data activity by the second application.

2. The computer-implemented method of claim 1, further comprising providing to the first service provider the client device identifier when a transaction is performed by the first application with the client device.

3. The computer-implemented method of claim 1, further comprising identifying the client device as a new client device for an old user in a network hosted by the first service provider, and installing the second application in the client device.

4. The computer-implemented method of claim 1, further comprising providing to the client device, for storage, a first identification value for the user in a network hosted by the first service provider based on the client device identifier.

5. The computer-implemented method of claim 1, further comprising providing to the first service provider or to the second service provider the client device identifier when a transaction is performed by the second application with the client device.

6. The computer-implemented method of claim 1, further comprising providing to the client device, for storage, a second identification value for the user in a network hosted by the second service provider based on the client device identifier.

7. The computer-implemented method of claim 1, further comprising querying the client device for an authorization to install the second application when the second service provider identifies the client device identifier as a previous account user.

8. The computer-implemented method of claim 1, wherein rewarding a user account in the first service provider comprises providing a personalized value added certificate to the user for a product included in the advertisement from the second service provider.

9. The computer-implemented method of claim 1, further comprising rewarding a user account in the second service provider when the user allows tracking data activity from the second application.

10. The computer-implemented method of claim 1, further comprising rewarding a user account in the second service provider when the second application detects a transaction with the client device associated with the advertisement.

11. A system, comprising;
one or more processors; and
a memory storing instructions which, when executed by the one or more processors cause the system to perform operations, comprising:
receive, in a first service provider, a request for downloading a first application into a client device from a user, the request including an authorization for the first service provider to track a data activity from the first application;
transmit, to a second service provider, a client device identifier, wherein the second service provider is enabled to place an advertisement in a display for the first application;
place the advertisement from the second service provider in the first application, wherein the advertisement entices the user to download a second application hosted by the second service provider when the client device identifier indicates that the user is a former subscriber to the second application;
reward a user account in the first service provider when the user allows the second service provider to track data activity from the second application; and
provide to the first service provider the client device identifier when a transaction is performed by the first application with the client device.

12. The system of claim 11, wherein the one or more processors further execute instructions to provide to the first service provider or to the second service provider the client device identifier when a transaction is performed by the second application with the client device.

13. The system of claim 11, wherein the one or more processors further execute instructions to provide to the client device, for storage, a first identification value for the user in a network hosted by the first service provider based on the client device identifier.

14. The system of claim 11, wherein the one or more processors further execute instructions to provide to the client device, for storage, a second identification value for the user in a network hosted by the second service provider based on the client device identifier.

15. A computer-implemented method, comprising:
requesting an advertising space in a display of a client device for a first application hosted by a first service provider;
receiving a client device identifier from the first service provider when a user uploads the first application in a mobile device;
correlating the client device identifier with a user identifier associated with a second application in a database;
preparing a payload for the advertising space, wherein the payload includes a request for the user to upload the second application in the mobile device;
requesting the user to enable a transaction tracking from the second application; and
rewarding a user account in the first service provider when the user enables the transaction tracking from the second application.

16. The computer-implemented method of claim 15, further comprising providing to the client device, for storage, a first identification value for the user in a network hosted by the first service provider based on the client device identifier.

17. The computer-implemented method of claim 15, further comprising providing to the first service provider or to a second service provider the client device identifier when a transaction is performed by the second application with the client device, wherein the second service provider hosts the second application.

18. The computer-implemented method of claim 15, further comprising providing to the client device, for storage, a second identification value for the user in a network hosted by a second service provider based on the client device identifier, wherein the second service provider also hosts the second application.

19. The computer-implemented method of claim 15, further comprising querying the client device for an authorization to install the second application when the first service provider identifies the client device identifier as a previous account user.

20. The computer-implemented method of claim 15, wherein preparing a payload for the advertising space comprises selecting the payload based on the transaction tracking from the second application.
